(19) United States
(12) Patent Application Publication
(10) Pub. No.: US 2020/0313459 A1
(43) Pub. Date: Oct. 1, 2020

(54) NETWORK MANAGEMENT

(71) Applicant: Smarter Grid Solutions Ltd, Glasgow (GB)

(72) Inventors: Robert CURRIE, Glasgow (GB); Liam MACISAAC, Glasgow (GB); Iain SMITH, Glasgow (GB); Neil MCNEILL, Glasgow (GB)

(21) Appl. No.: 16/635,082

(22) PCT Filed: Jul. 30, 2018
(86) PCT No.: PCT/GB2018/052173

§ 371 Date: Jan. 29, 2020

(30) Foreign Application Priority Data
Jul. 31, 2017 (GB) 1712252.4

(51) Int. Cl. H02J 13/00

(52) U.S. Cl. CPC H02J 13/00004; H02J 13/00007; H02J 13/00002

(57) ABSTRACT

A control system for a power network, the control system comprising at least one monitoring device or constraint controller for monitoring, determining or measuring at least one parameter of one or more points, such as constraint locations, on the power network; and one or more device controllers for controlling at least one device connected or connectable to the power network; wherein the at least one monitoring device is configured to broadcast a request or objective based and/or dependent on the at least one measured or monitored parameter. The one or more device controllers are configured to receive or retrieve the broadcast request or objective and to determine a control action for the at least one device at least partially based on the request or objective. In this way, the control system may logically separate the determining of a condition of the point on the network from the decision of how to control the devices in order to resolve the condition. Also included herein are a corresponding power network, constraint controller, device controller, method and computer program.

### FIELD

The present disclosure relates to an active network management (ANM) scheme to manage power networks.

### BACKGROUND

Existing power networks were not designed to accommodate the high capacity of power producing devices, particularly from renewable sources, that are now being connected and are expected to be connected over the coming decades. Equally, the existing network and the way it is planned and operated places a finite limit on the capacity of power consuming devices that can be connected. Upgrading, replacing or building new network infrastructure, particularly overhead lines and underground cables, can be expensive, damaging to the environment, and take a very long time to implement, due in part to planning objections and constraints. Active network management (ANM) can enhance the useable capacity of power networks and thereby facilitate the connection and use of a higher capacity of power producing and/or consuming devices, including new renewable energy sources and energy storage. In this way, ANM provides an alternative to network reinforcement and performs a Smart Grid function to enable low carbon power networks.

The Energy Networks Association (ENA) have published an Active Network Management Good Practice Guide (Energy Networks Association, London (2015)—http://www.energynetworks.org/assets/files/news/publications/1500205_ENA_ANM_re port_AW_online.pdf). This document sets out current good practice for the commercial arrangements and technical deployment of ANM technologies. The contents of this document are incorporated herein by reference as if set out in full and are not reproduced herein only for brevity.

The role of ANM in mitigating voltage constraints and thereby facilitating the connection of an individual new power producing device is recognised in an official UK electricity industry document, Engineering Technical Report 126: “Guidelines for Actively Managing Voltage Levels Associated with the Connection of a Single Distributed Generation Plant”, Energy Networks Association, August 2004. The purpose of Engineering Technical Report (ETR) 126 is to provide electricity Distribution Network Operators (DNOs) with guidance on how to employ ANM solutions to overcome voltage control limitations associated with the connection of a single distributed generation (DG) device.

GB 2421596A describes a system for controlling voltage in power networks with DG. A voltage measurement is taken on the controlled terminals of the on-load tap changing transformer. Current measurements are taken on the primary side of the on-load tap changing transformer and on each feeder that has DG connected. The measurements must be able to provide the phase difference between voltage and current. From these measurements the system calculates a “voltage boost” to compensate for voltage drops due to load and a “voltage adjustment” (or “voltage buck”) to compensate for voltage fluctuations caused by DG. This changes the operating position of a single device, namely the transformer tap position, but does not address generator control or the coordinated control of multiple devices by scaling the methods across a broader power system.

There is a tendency in the prior art to rely on centralized network control solutions that use central controllers to centrally control the network components. A central controller in such systems accepts one or more measurements in order to perform the control operation. The central controller of the system is also responsible for performing calculations that enable control signals to be sent to one or more controlled devices. These control signals specify control of the controlled devices required to satisfy control logic implemented by the central controller. However, as more controlled devices or sensors are added to the system, the processing time required at the central controller to compute control signals for each of the devices may increase. This may eventually result in a processing time that is unacceptable for resolving thermal or voltage constraints on an electrical power network. Furthermore, this arrangement also may not adequately address situations in which changes to operation of a device may have an effect on more than one location, or where different locations require different operations of the device.

At least one example of the present invention seeks to mitigate or eliminate at least one problem with the prior art.

### SUMMARY

The decoupling of the network components has not been sufficiently addressed in the prior art but is described herein. This is a crucial aspect of being able to scale the application of ANM methods.

Various aspects of the present disclosure are defined in the independent claims. Some preferred features are defined in the dependent claims.

According to a first aspect of the present disclosure there is provided a control system for a power network, the control system comprising:
at least one monitoring device for monitoring, determining or measuring at least one parameter of one or more points on the power network; and
one or more device controllers for controlling at least one device connected or connectable to the power network; wherein
the at least one monitoring device is configured to broadcast or transmit a signal based and/or dependent on the at least one measured or monitored parameter or a condition derived therefrom. The signal may comprise a request or objective that may depend on the parameter or the condition of the one or more points on the power network derived therefrom. The one or more device controllers may be configured to retrieve or receive the broadcast or transmitted request or objective and may be configured to determine a control action for the at least one device at least partially based on the request or objective. The monitoring, determining and measuring of the parameters of the one or more points on the power network may be physically and/or logically decoupled or separated from the control of the devices.

The monitoring device may be a constraint controller.

The monitoring of the one or more points on the power network may be logically decoupled or physically decoupled or physically separated from the control of the devices. The at least one monitoring device (e.g. constraint controller) may be logically, functionally and/or physically distinct, decoupled and/or separate from the one or more device controllers. In this way, the at least one monitoring device that makes the measurements of the parameters and/or determines a requirement, request and/or objective for the at least one point on the network, may be separate from the device controller(s) that determines how to control the devices in order to meet the control the devices that are connected to the power network that affect the parameters.

For example, the at least one monitoring device (e.g. constraint controller) may be physically separated, remote and/or distinct from the one or more device controllers. For example, the at least one monitoring device or constraint controller may optionally but not essentially be provided at the one or more points on the network and/or the one or more device controllers may optionally but not essentially be provided at or in the respective devices.

The at least one point on the network may be or comprise a constraint point. The constraint point may be or comprise a location of the power network where one or more parameter limits are breachable, e.g. by adding further devices, such as electricity generation devices, and/or otherwise. The constraint point may be a point on the power network provided with one or more sensors or monitoring devices, e.g. for monitoring current, voltage and/or other electrical parameters. The one or more sensors may be comprised in, in communication with or coupled to one or more of the at least one monitoring devices.

The constraint point may be a constraint in a zone or constraint location as described in EP2208273, the contents of which are incorporated by reference as if set out in full herein.

The at least one monitoring device may be configured to determine the condition of the at least one point on the network (e.g. constraint location) at least in part from the at least one parameter of one or more points on the power network. The at least one monitor may be broadcast or transmit the signal based and/or dependent on the determined condition. The determined condition may be dependent on the at least one parameter of one or more points on the power network.

The control system may be a decentralized control system. The signal may be or comprise a requirement, request and/or objective. The requirement, request and/or objective may be or comprise a requirement, request and/or objective for the one or more points on the network (e.g. constraint location), e.g. for the at least one parameter of the one or more points on the network. The request may not specify an operation or target parameter value for the at least one device that is connected or connectable to the power network. The at least one monitoring device may be configured to broadcast or transmit the requirement, request and/or objective based and/or dependent on the at least one measured or monitored parameter and/or the determined condition. The request may indicate a desired objective. The signal may not be or comprise a control command, may not specify an action and/or may not comprise a specified action for any of the device controllers to take. Instead, the requirement, request or objective may be indicative of an objective to be achieved or requirement that would be desirable for the one or the points on the power network associated with or monitored by the monitoring device that sent the request, e.g. to resolve an unwanted condition at the point on the power network (e.g. at the constraint location).

In this way the monitoring device may be configured to broadcast or transmit the requirement, request or objective, that is receivable by one or more or all of the device controllers, that may be indicative of a desire or objective to be achieved for the associated or monitored point on the power network, e.g. rather than a control command that compels or commands the device controller to operate the at least one device to take a specific or specified action. It may then be up to the one or more device controllers to determine what action to take and/or what control action to issue based on the request or objective and/or one or more other requests or objectives received from at least one other of the monitoring devices and optionally also a current state and/or condition of the at least one device that may be controlled, controllable or managed by the one or more device controllers. The one or more device controllers may be configured to determine how to control the at least one devices controlled, controllable or managed by the device controller based on the request and/or in order to achieve the objective and/or based on the one or more other requests or objectives received from the at least one other of the monitoring devices.

In this way, the monitoring device, e.g. the constraint controller, may set the objective to be achieved based on the measured value of the at least one parameter of the one or more points on the power network (e.g. the constraint points) but may not specify how the objective is achieved, whereas the device controller may determine how the devices should be controlled in order to meet the objective. This effectively results in a logical separation or decoupling of the measurement of the at least one parameter of the one or more points on the power network (e.g. at the constraint locations) from the control of the at least one device used to control the values of the at least one parameter.

Logic for controlling the at least one device that is connected or connectable to the power network may be distributed and/or localised. For example, logic for determining what action the at least one device that is connected or connectable to the power network should take may be distributed to, localised to and/or provided on the plurality of device controllers and may not be provided on the constraint controllers. The logic may determine an action, set point or target for a parameter of the at least one device in response to the request or objective for the one or more points on the power network (e.g. the constraint points). The system may implement the logic without the use of centralised controllers that control multiple devices, e.g. all of the devices for the entire network or for at least an area or section of the network. In other words, the logic for determining what action the at least one device may be localised to the device controller rather than being taken centrally by a central controller.

The control system may be a decentralized, distributed system in which the logic for determining how to operate a device may be distributed to individual device controllers whilst the measurement of the at least one parameter of the constraint locations on the network and the setting of goals or objectives based thereon may be carried out by a separate constraint controller. This may contrast with a centralized system in which these functions may be carried out by a common or central controller. In this way, a control system that is more scalable and/or adaptable to changes in the network may be provided.

The requirement, request or objective may specify, for example, one or more of: reducing the value of the at least one parameter of the one or more points on the power network (e.g. when the value of the parameter is above a threshold); increasing the value of the at least one parameter of the one or more points on the power network (e.g. when the value of the parameter is below a threshold); releasing control of at least one of the devices (e.g. when the value of the parameter is within an operational or release range); controlling the ramp rate of a parameter at one or more points on the power network; and/or fail safe or other safe condition (e.g. when the monitoring device has lost communication with sensors for measuring the at least one parameter or the value of the at least one parameter is a predetermined value indicative of an error).

The signal broadcast or transmitted by the at least one monitoring device may be received or receivable by one or more or all of the device controllers. The signal may be broadcast or transmitted by the at least one monitoring device without knowledge and/or designation of the one or more or all of the device controllers. The one or more device controllers may be configured to determine a control action for the at least one device at least partially based on the signal and/or one or more other signals received from at least one other of the monitoring devices, and optionally also a current state and/or a condition of the at least one device, e.g. at least one device that may be controlled, controllable or managed by the one or more device controllers.

The control system (e.g. the one or more device controllers) may be configured to determine the control actions without reference to a model of the full network. As each device controller is provided with logic to determine how to control the device or devices associated with it, e.g. the control logic may be distributed to individual device controllers, then there may be no need for a use of a full network model.

The monitoring device or constraint controller may be configured to implement a control algorithm for determining a condition of the point on the network, e.g. from a plurality of possible conditions. The monitoring device or constraint controller may be configured to broadcast different requirements, requests or objectives for different determined conditions. The control algorithm may comprise one or a plurality of criteria, ranges or thresholds or pairs of thresholds, of the at least one parameter or a rate of change or ramp rate thereof. The control algorithm may specify a respective requirement, request or objective to be broadcast when the respective criteria, range, threshold or pair of thresholds are met, exceeded or breached.

The control algorithm may be a predetermined, pre-set, pre-provided or programmed algorithm. The control algorithm may specify or be useable to determine when the signal, e.g. the requirement, request or objective, should be broadcast and/or what signal, e.g. what requirement, request or objective, should be broadcast, e.g. based on the measured or determined value of the at least one parameter or the rate of change or ramp rate thereof.

The device controller may be configured to receive requests or objectives from a plurality of different monitoring devices or constraint controllers for corresponding different points on the power network. The device controller may be configured to arbitrate and/or otherwise take into account the requests or objectives from the plurality of different monitoring devices or constraint controllers in determining the control action for the at least one device. The requirement, request or objective may comprise a priority. The device controller may be configured to determine how to control the at least one device associated with, e.g. controlled, controllable or managed by, the device controller at least partially based on the priority of the request and/or the priority of the one or more other requests received from the at least one other of the monitoring devices. The device controller may be configured to use the priority of requests as part of a conflicts and arbitration policy. The device controller may be configured to prioritize requests having a higher priority over requests having a lower priority. The device controllers may be configured to communicate, collaborate and/or coordinate with each other in order to implement the conflicts and arbitration policy.

The device controller may be configured to determine which of the at least one devices to control and/or how to control the at least one device associated with, e.g. controlled, controllable or managed by, the device controller based on a policy or control strategy, which may comprise the conflict and arbitration policy, which may be predefined. The policy or control strategy may specify which devices to control and/or how and/or when to control the devices, e.g. based on one or more factors, which may include one or more of: the priority of at least one or more of each signal received; the identity, type or other property of the monitoring device(s) from which the signal was received; a sensitivity or mapping of the parameter or condition of the constraint location to changes at the device; the identity, type or other property of the one or more points on the power network associated with or monitored by the monitoring device(s) from which the signal was received; the rate of change or ramp rate of the parameter; and/or the like. The one or more factors may be comprised in the signal. The policy or control strategy may comprise or be comprised in a look-up table, algorithm, parameter map, correspondence table or other suitable means. The policy or control strategy may contain information required to determine which of the at least one devices to control and/or how to control the at least one device from the one or more factors.

The policy or control strategy may specify how to determine which of the at least one devices to control and/or how to control the at least one device when a plurality of signals (e.g. requests or objectives) are received from a plurality of monitoring devices (e.g. the plurality of constraint controllers), at least partially based on, for example, one or more of: the priority of at least one or more or each signal, request or objective received; the identity, type or other property of the monitoring device(s); the identity, type or other property of the one or more points on the power network associated with or monitored by the monitoring device(s); and/or the like.

The device controller may be provided with the sensitivity and/or mapping of the parameter or condition of at least some or all of the constraint locations to changes at the device, e.g. as a determined or pre-provided or dynamically updated database, look-up table, algorithm, and/or the like. For example, the sensitivity or mapping may be provided to the device controller as a table of pre-configured sensitivity or mapping values dependent on network topology and the device controller may receive an external signal indicating the network topology. In another example, the device controller may be configured to communicate with an external system that calculates and provides the device controller with information about its sensitivity or mapping, which may be updated dynamically and/or on the fly.

The at least one parameter may comprise one or more or each of: voltage, current, real power, reactive power, and/or apparent power, e.g. at the relevant point on the power network, and/or the like. The value of the at least one parameter (e.g. real power, reactive power, current or voltage) at the one or more points on the network (e.g. constraint locations) may be controlled at the measurement controller, e.g. at the measurement controller location, by the setting of the objective or request.

The control action determined by the device controller may comprise a device trip command, a global trip command, a reduction in output or consumption command, an increase in output or consumption command, a set-point change command, and/or the like. The control action may comprise setting, altering or setting a target point for a property of the device, such as a circuit breaker position, real and/or reactive power, and/or the like. The property of the device may be determined by the device controller, e.g. at the device controller location.

One or more of the devices may comprise at least one power generation or producing device. One or more of the devices may comprise at least one power consuming device. One or more of the devices may comprise or be comprised in another network or sub-network, such as a third party network. In other words, the network may comprise or span a plurality of networks or sub-networks owned and/or operated by a plurality of owners or operators. The monitoring system (e.g. constraint controller) may be provided or operated by one vendor or operator, e.g. as a service, while the device controller may be provided by a different vendor or operator, e.g. as a service, to satisfy the objectives or requests set by the monitoring system.

The at least one device may be a device that has an effect, such as an effect greater than a predetermined minimum effect, on the one or more points on the power network (e.g. on the at least one parameter of the one or more points on the power network) and is controlled by an at least one device controller. The one or more device controllers may be configured to only respond to, act on, or control the devices responsive to, signals from those monitoring devices that monitor, measure or are associated with the one or more points on the power network that are affected by the one or more devices controlled by that device controller. The one or more device controllers may be provided with data indicating the one or more points on the power network that are affected by the one or more devices controlled by that device controller, and/or the one or more monitoring devices associated therewith. Data indicative of the points on the power network and/or monitoring device may be comprised in the signal broadcast or transmitted by the monitoring device.

The at least one monitoring device may be configured to determine if the at least one parameter of the one or more points on the power network is outwith one or more, e.g. a plurality of, ranges and/or above or below one or more thresholds. The at least one monitoring device may be configured to signal, e.g. send a request or objective to, the at least one device controller when the at least one measured or monitored parameter is outwith the one or more ranges and/or above or below the one or more thresholds. Two or more or each of the ranges and/or thresholds may be associated with a different condition or request.

Each of the plurality of ranges, thresholds or pairs of thresholds (e.g. upper and lower thresholds) may be associated with a different request, objective or requirement.

For example, at least one of the ranges and/or thresholds may be or comprise a release trigger range and/or a release trigger upper threshold and/or a release trigger lower threshold. When the at least one parameter for a point on the power network is within the release trigger range and/or below the release trigger upper threshold and above the release trigger lower threshold, then this may be indicative that no device control actions are required for that point on the power network and/or the devices that have an effect on that point on the power network may be returned to their preferred or normal operating set points. The at least one monitoring device may be configured to send a signal that is or comprises a release trigger request when the at least one monitored parameter is within the release trigger range and/or below the release trigger upper threshold and above the release trigger lower threshold.

At least one or more or each threshold may be or comprise a trigger level, such as any or all of the trigger levels described in EP2648302, the contents of which are hereby incorporated by reference as if set out in full herein.

The at least one device controller may be configured to factor in or otherwise take into account the release trigger request when controlling the at least one device, e.g. according to the policy or control strategy for that device controller.

For example, if no other monitoring device has broadcasted or transmitted a currently active signal that requires the at least one device to be at anything other than the preferred or normal operating set point, or if the policy or control strategy of the device controller stipulates that the release trigger request has priority over other requests currently received from other monitoring devices, then the device controller may be configured to return the at least one device that has an effect on the at least one point on the power network monitored by the monitoring device to their preferred or normal operating set points responsive to receiving the trigger release request for that point on the power network, optionally whilst maintaining the parameter for the at least one point on the power network within a release range or below a release upper threshold and above a release lower threshold.

At least one of the ranges and/or thresholds may be or comprise at least a plurality of action ranges and/or upper and lower thresholds, e.g. a first and/or second action range and/or at least first and/or second upper thresholds and/or at least first and/or second lower thresholds.

When the at least one parameter for a point on the power network is outwith the first active range and/or above the first upper threshold or below the first lower threshold, then this may be indicative that the at least one parameter for that point on the power network needs reduced or increased as appropriate, e.g. to return the value of the at least one parameter to within the release trigger range or to a value between the release trigger upper threshold and release trigger lower threshold. The at least one monitoring device may be configured to broadcast or transmit a signal that is or comprises a first action request when the at least one monitored parameter is outwith the first active range and/or above the first upper threshold and below the first lower threshold. The at least one device controller may be configured to factor in or otherwise take into account the first action request when controlling the at least one device, e.g. according to the policy or control strategy for that device controller.

For example, if the policy or control strategy of the device controller stipulates that the monitoring device that broadcasted or transmitted the first action request has priority over other requests currently received from other monitoring devices, then the device controller may be configured to operate the at least one device that has an effect on the at least one point on the power network monitored by the monitoring device responsive to the first action request, e.g. by reducing the output of the at least one device (if the device is a generation device) or by increasing the consumption or operation of the device (if the device is a power consuming device) if the at least one parameter is above the first upper threshold or by increasing the output of the at least one device (if the device is a generation device) or by decreasing the consumption or operation of the device (if the device is a power consuming device) if the at least one parameter is below the first lower threshold.

When the at least one parameter for a point on the power network is outwith the second active range and/or above the second upper threshold or below the second lower threshold, then this may be indicative that the at least one device, e.g. at least one device that has an effect on the parameter of the one or more points on the power network, should be reduced or increased as appropriate with a higher priority than that associated with the first action request or tripped or switched out or that a plurality of devices should be sequentially tripped or switched out, e.g. until the at least one parameter is back within the release trigger range or between the upper and lower release trigger thresholds. The at least one monitoring device may be configured to send a signal that is or comprises a second action request when the at least one monitored parameter is outwith the second active range and/or above the second upper threshold and below the second lower threshold and/or after the expiration of a period of time. The at least one device controller may be configured to factor in or otherwise take into account the second action request when controlling the at least one device, e.g. according to the policy or control strategy for that device controller.

For example, if the policy or control strategy of the device controller stipulates that the second action request has priority over other requests currently received from other monitoring devices, then the device controller may be configured to operate the at least one device that has an effect on the at least one point on the power network monitored by the monitoring device responsive to the second action request, e.g. by reducing or increasing the output of the device, tripping, switching out or sequentially tripping or switching out the at least one device if the at least one parameter is above the second upper threshold.

The sending of the request may be dependent on a ramp rate or rate of change of the at least one parameter. One or more or each of the thresholds may be based on a previous measurement of the at least one parameter. One or more or each of the thresholds may be recalculated, e.g. periodically or for at least one or more or each time period, e.g. consecutive time periods or seasonal time periods. The thresholds may be set relative to the value of the previous measurement of the at least one parameter for a preceding or previous time period, e.g. the thresholds may be set to a determined or predetermined amount above and/or below the previous measurement of the at least one parameter for the preceding or previous time period.

The at least one monitoring device (e.g. constraint controller) may be provided at the respective points on the network (e.g. the respective constraint locations). The one or more device controllers may be provided at or in the devices. The devices may be distributed and/or remote from the constraint controllers. The at least one monitoring device (e.g. constraint controller) may be coupled or connected to, or configured to communicate with or in communication with the one or more or each device controller, e.g. via a data network, such as a wired or wireless data network, or via a bus, such as an enterprise service or message bus. The communications via the at least one monitoring device (e.g. constraint controller) and the one or more device controllers may be configured to communicate using a publish-subscribe protocol, an industry standard telemetry protocol, such as OpenFMB, GOOSE, IEC-61850 or DNP3, and/or the like. The specification for these protocols may be as specified in the relevant protocol, e.g. Noth American Electricity Standards Board, RMQ.26 OpenFMB, 2016 or IEC, 61850 7-2 GSE (GOOSE and GSSE), 2010, which are incorporated in full by reference. The at least one monitor may be configured to broadcast or transmit the signal over the communications network. One or more or all of the device controllers may be configured to receive the signals broadcast or transmitted by one or more or all of the monitoring devices over the communications network.

The communications network may comprise, be coupled to or configured to implement a request queue. The monitoring devices may be configured to broadcast or transmit the signal by issuing the signal to the request queue. The request may be queued in the request queue. One or more or all of the device controllers may be configured to retrieve and/or consume the requests from the request queue.

As part of the publish-subscribe protocol, the at least one monitor may publish the signal with a classification, e.g. indicating the point on the network, a location, a zone, a monitoring device id, and/or the like. The one or more device controllers may be configured to subscribe to, retrieve from the request queue and/or receive signals having a classification that indicates that the signals are from the one or more points on the power network that are affected by the one or more devices controlled by that device controller.

Optionally, the at least one monitoring device (e.g. constraint controller) and/or the one or more device controllers may be configured to implement an open loop control. The at least one monitoring device (e.g. constraint controller) may be configured to issue subsequent signals (e.g. requests or objectives), e.g. if a release trigger condition is not satisfied or a release trigger range is not achieved. There may be no feedback from the one or more device controllers to the at least one monitoring device, i.e. the at least one monitoring device may be configured to broadcast or transmit the signals, e.g. to the request queue, and the one or more device controllers may be configured to receive, retrieve and/or consume the signals, e.g. from the request queue.

The power network may comprise a plurality of device controllers. Each device controller may be associated with or configured to control a different part of the network, e.g. different devices, to at least one or each other device controller. In other words, optionally each device may be controlled by only one device controller. However, a device controller may control one or optionally multiple devices.

A plurality of device controllers may act responsive to the signal. The plurality of device controllers may be configured to communicate and/or coordinate with each other, e.g. via the data network or bus, to determine a coordinated response by the plurality of device or device controllers to the signal.

The power network may comprise or be comprised in a power network as described in, and/or may comprise one or more features described in, GB2460504, the contents of which are incorporated herein by reference as if they had been set out in full herein. In particular, the power network may be or comprise a zoned network.

The power network may effectively decouple the monitoring of constraint points with the control of the devices. In particular, the constraint controllers may monitor the values of the parameters at the associated constraint points in the power network but may not directly control the devices connected to the network that affect the parameters at the associated constraint points. Instead, the constraint controller may issue requests or objectives to be met by one or more of the device controllers. The one or more device controllers control the one or more devices and may be configured to determine how to control the one or more devices to respond to or satisfy the request or objective, e.g. based on the policy or control strategy with which each device controller has been provided.

The constraint controllers may implement the control algorithm that may use one or more thresholds and/or ranges of the at least one measured or determined parameter and/or the rate of change or ramp-rate thereof, to determine if a request or objective should be sent, what request or objective to send and/or a priority of the request or objective.

The device controller may then use the objective or request and/or the priority, along with any objective or requests and/or priorities received from other constraint controllers, to determine how to satisfy or respond to the objective(s) or request(s) from the constraint controller(s), e.g. according to the policy or control strategy.

The power network making use of the present disclosure may provide significant advantages. The separation of the controlling of the devices from the monitoring the parameters at the constraint points allows different control strategies to be employed at constraint locations to best suit the constraint location or a problem or operating requirement to be addressed. For example, at least two or each of the constraint controllers may utilise different control algorithms or strategies, e.g. at least one of the constraint controllers may utilise ramp-rate control to determine what request or objective should be provided, whilst at least one other of the constraint controllers may utilise one or more thresholds. As the monitoring and control are separate, the device controller may be agnostic to the control algorithms or strategies employed by the constraint controllers. The device controllers may simply receive requirements, requests or objectives from the constraint controllers and determine how to control the devices accordingly, regardless of the control algorithms or strategies employed by the individual constraint controllers.

Similarly it may be possible for the device controllers to be altered, upgraded, exchanged, replaced or re-programmed, e.g. to provide a new control strategy or policy. This may not affect the operation of the constraint controllers. For example, it may be possible to change between control of reactive power output of a generator with control of an on-load tap changer without making any change to the constraint controller.

The invention may make it easier to integrate different networks and network components belonging to different vendors or owners. For example, the network may comprise various combinations of constraint controllers and/or device controllers from one or more operators, or from different suppliers. The integration may be made easier by the separation of the monitoring and control, with the control being decided by the device controller responsive to requests or objectives provided by the constraint controllers rather than both monitoring and control being carried out in a single control application.

The device controllers may be configured with arbitration and/or conflict policies in order to deal with multiple requests from different constraint controllers. Priorities provided by the constraint controllers (e.g. based on particular thresholds being breached and/or on the type or location of the associated point on the network, or on the magnitude of the respective values of the parameter or rate of change of the parameter) may be used by the device controllers to arbitrate and/or otherwise resolve multiple requests from different constraint controllers.

According to a second aspect of the present disclosure there is provided a power network comprising the control system of the first aspect.

As such, the power network may comprise the at least one monitoring device for monitoring, determining or measuring at least one parameter of one or more points on the power network. The power network may comprise at least one device connected or connectable to the power network. The power network may comprise the one or more device controllers for controlling the at least one device. The at least one monitoring device may be configured to signal the at least one device controller based and/or dependent on the at least one measured or monitored parameter.

As the power network comprises the control system according to the first aspect, the at least one monitoring device and one or more device controllers may be the at least one monitoring device and one or more device controllers of the control system of the first aspect.

The monitoring device may be a constraint controller. The at least one point on the network may be or comprise a constraint point. The constraint point may be or comprise a location of the power network where one or more parameter limits are breachable by adding further devices, such as electricity generation devices. The constraint point may be a point on the power network provided with one or more sensors or monitoring devices, e.g. for monitoring current, voltage, power and/or another of the parameters. The one or more sensors may be comprised in, in communication with or coupled to one or more of the at least one monitoring devices. According to a third aspect of the present disclosure is a monitoring device for monitoring, determining or measuring at least one parameter of one or more points on the power network of the second aspect;
the monitoring device comprising, and/or being configured to receive data from, one or more data providing sensors for measuring or monitoring the one or more points on the power network;
the data comprising values of the one or more parameters and/or the monitoring device being configured to determine the values of the one or more parameters from the data; wherein
the monitoring device is configured to determine a signal, which may be or comprise a request or an objective, based on the values of the one or more parameters; and
broadcast or transmit the signal based and/or dependent on the at least one measured or monitored parameter or a condition derived therefrom.

The monitoring device may be comprised in the control system of the first aspect, i.e. the monitoring device may be, or may comprise one or more or each of the features of, the monitoring device described in relation to the first aspect.

The monitoring device may be a constraint controller.

The monitoring device may comprise a communications system. The communications system may be configured to broadcast or transmit the signal, e.g. over a data network or bus. The data network or bus may comprise, be configured to implement or be connected to a request queue. At least one device controller may be configured to retrieve the signal, e.g. from the request queue. The communications system may be configured to operate according to a publish-subscribe protocol. The monitoring device may be configured to publish the signal by broadcasting it via the data network or bus. The monitoring device may not know anything about the device controllers and may not address or tailor requests to specific device controllers. Instead, the requests may be generic and may be applicable to many or all of the device controllers.

The monitoring device may be configured to determine if the value and/or ramp rate of the at least one parameter is within or outwith at least one range and/or determine if the value or ramp rate of the at least one parameter is above or below at least one threshold, and the monitoring device may determine, select or provide the signal, e.g. the request or objective, dependent thereon.

The monitoring device may comprise a processor and at least one memory and/or data storage. The processor may be coupled to the communications system. The processor may be configured to determine the values of the one or more parameters from the data. The processor may be configured to determine the signal, e.g. the request or objective, based on the values of the one or more parameters or the ramp rate or rate of change thereof. The processor may be configured to provide the signal to the communications system, e.g. for sending to the at least one device controller. The communications system may be a one-way communications system, e.g. it may be configured to broadcast the signals but may not receive signals.

The device controller may comprise one or more features of the device controller described above in relation to the first aspect.

According to a fourth aspect of the present disclosure is a device controller, the device controller being configured to:
retrieve or receive at least one signal that was broadcast or transmitted by one or more monitoring devices, e.g. constraint controllers;
determine a control scheme for controlling one or more devices connected to an power network based on the retrieved or received signal(s); and
control the at least one devices based on the determined control scheme or algorithm.

The device controller may be comprised in the control system of the first aspect, i.e. the device controller may be or comprise one or more or each of the features of the device controller described in relation to the first aspect.

The signals may comprise a request, an objective and/or a priority. The signals may not comprise a control command that directly controls the devices.

The device controller may comprise a processor, a memory and/or a data store. The device controller may comprise a communications module configured to retrieve or receive the signals and/or to communicate with other device controllers. The device controller (e.g. the processor) may be configured to determine the control scheme based on the retrieved or received signal(s), e.g. based on the received requests, objectives and/or the associated priorities, and optionally by additionally using a policy or control strategy, which may be pre-determined or otherwise stored in the memory or data store.

The device controller may be, or may comprise at least one feature of, a device controller described above in relation to the first aspect. The device controller may be configured for use in or with the control system of the first aspect, the power network of the second aspect and/or with the monitoring device of the third aspect.

According to a fifth aspect of the present invention is a method of operating a control system. The control system may be the control system according to the first aspect or comprised in the power network of the second aspect.

The method may comprise:
monitoring, determining or measuring at least one parameter of one or more points on the power network using at least one monitoring device;
using the at least one monitoring device, broadcasting or transmitting a signal based and/or dependent on the at least one measured or monitored parameter;
retrieving or receiving the signal using the at least one device controller; and
controlling the at least one device using one or more device controllers at least partly based on the signal.

According to a sixth aspect of the present invention is a computer program or computer program product configured such that when run on a processing system causes the processing system to implement the method of the fifth aspect. The computer program or computer program product may be provided on a tangible, non-transient carrier medium.

It should be understood that the individual features and/or combinations of features defined above in accordance with any aspect of the present invention or below in relation to any specific embodiment of the invention may be utilised, either separately and individually, alone or in combination with any other defined feature, in any other aspect or embodiment of the invention.

Furthermore, the present invention is intended to cover apparatus configured to perform any feature described herein in relation to a method and/or a method of using or producing, using or manufacturing any apparatus feature described herein.

A skilled person will realise that the solution offered by the present invention could allow for voltage management and/or could be combined with the power flow management solution offered by Currie and Ault (WO 2009/063220 A2), e.g. to deliver simultaneous and co-ordinated management of voltages and power flows.

### BRIEF DESCRIPTION OF THE DRAWINGS

Various aspects of the disclosure will now be described by way of example only and with reference to the accompanying drawings, of which:

FIG. 1 is simplified schematic of part of a power network;

FIG. 2 is a schematic of a control system for a power network, such as that of FIG. 1;

FIG. 3 is a flowchart showing a method of operation of the control system of FIG. 2;

FIG. 4 is a schematic illustration of a control algorithm for use in a power network control system, such as that of FIG. 2;

FIG. 5 is a schematic illustration of an alternative control algorithm for use in a power network control system, such as that of FIG. 2;

FIG. 6 is a flowchart showing the operation of the control algorithm of FIG. 4;

FIG. 7 is a flowchart showing the operation of the control algorithm of FIG. 5;

FIG. 8 is a schematic illustration showing an exemplary implementation of the control system of FIG. 2 in a power network, such as that of FIG. 1;

FIG. 9 shows an example of an application of the control algorithm of FIG. 4 to the control system of FIG. 8;

FIG. 10 shows an exemplary process flow illustrating the application of the control algorithm of FIG. 4 to the control system of FIG. 8;

FIG. 11 is a schematic illustration showing an alternative exemplary implementation of the control system of FIG. 2 in a power network, such as that of FIG. 1;

FIG. 12 shows an example of an application of the control algorithm of FIG. 5 to the control system of FIG. 11; and

FIG. 13 shows an exemplary process flow illustrating the application of the control algorithm of FIG. 5 to the control system of FIG. 11.

### DETAILED DESCRIPTION OF THE DRAWINGS

The present invention presents an active network management scheme that effectively decouples the monitoring of constraint points from the control of devices coupled to the network, such as power generation devices. In particular, constraint controllers monitor the values of the parameters at the associated constraint points in the power network but do not directly control the devices connected to the network that affect the parameters at the associated constraint points. Instead, the constraint controller issues objectives to one or more device controllers. The device controllers determine how to control the one or more devices to respond to or satisfy the objective (and any other objectives received from other constraint controllers) and adjust control of the devices accordingly.

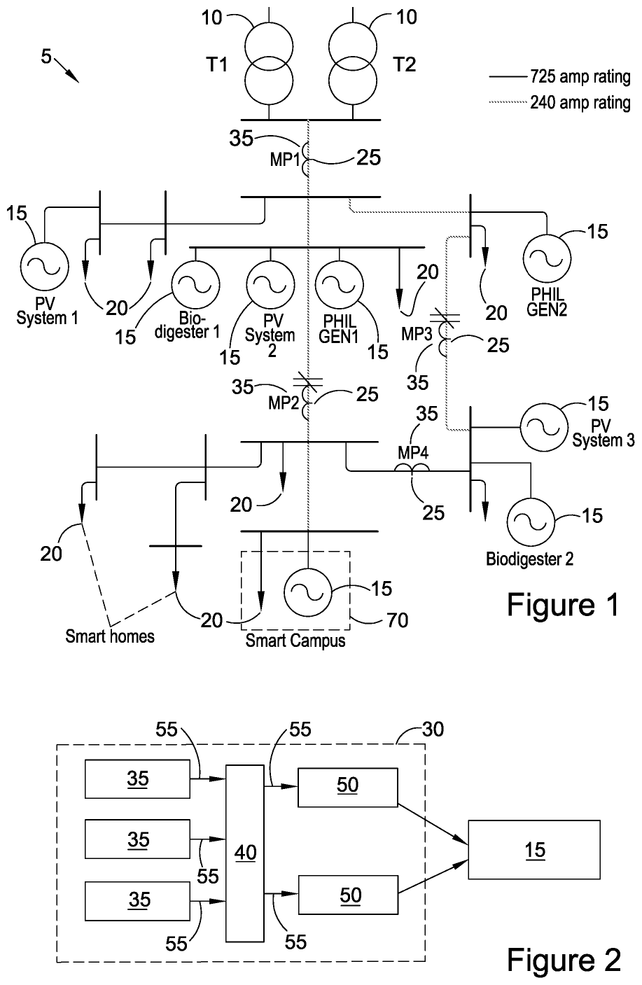

FIG. 1 shows a part of a power network 5, such as a portion of the electricity supply grid. The power network 5 comprises wider grid connections 10 and a variety of distributed devices including generation resources 15 such as photovoltaic cell arrays, biodigesters, and other generation types that would be apparent to a skilled person, particularly renewables/small scale renewables. The devices also include devices 20 that draw power from the power network 5 such as homes, commercial customers, and the like, which may advantageously comprise a smart campus or other third party microgrid or small scale network.

The power network 5 comprises various constraint locations 25, each provided with a measuring system, indicated as MP1, MP2, MP3, MP4, for measuring one or more parameters of the power network 5 at the respective constraint location 25. Examples of the one or more parameters that are measured might include current, voltage, real power, reactive power, apparent power and/or the like. It will be clear that some parameters could be measured directly and some parameters could be determined from other measured parameters and both possibilities and/or any combination thereof could be used.

The constraint locations 25 shown in FIG. 1 comprise power flow constraint locations. However, it would be appreciated that alternative constraint locations could comprise voltage constraint locations (e.g. which could be provided on busbars BusXXX) and/or thermal constraint locations, where voltage or thermal capacity is likely to be a limiting factor. For example, these might correspond to the locations on the power network 5 with the lowest voltage, power and/or thermal capacity, at least relative to the expected, normal or average voltage, power or temperature at those locations. The constraint locations 25 are the locations where voltage and power flow limits would most likely be exceeded if more generation resource 15 were to be added to the power network 5. Methods for identifying constraint locations in power networks are known in the art, for example, as described in EP2208273, the contents of which are hereby incorporated by reference as if set out in full herein.

FIG. 2 shows a control system 30 for at least partially controlling a power network, such as (but not limited to) that of FIG. 1. The control system comprises a plurality of monitoring devices (in this example in the form of constraint controllers 35), a request queue 40, and a plurality of device controllers 50 that each control some of the devices, particularly the generation resources 15.

In this example, each constraint controller 35 is associated with a corresponding constraint location 25 and receives the values of the parameters from the measuring system MP1, MP2, MP3, MP4 that measures the parameters at that constraint location 25. In this example, one constraint controller 35 is provided for each constraint location 25. However, it will be appreciated that this need not be the case and instead at least some or all of the constraint controllers 35 can each be associated with multiple constraint locations 25 and receive the parameter values from multiple measurement systems MP1, MP2, MP3, MP4.

The constraint controllers 35 are configured to monitor the constraint locations 25 and particularly the values of the parameters at the constraint locations 25, to assess the values of the parameters using a control algorithm, and to issue requests 55 containing at least an objective and a priority depending on the results of that assessment, as specified by the control algorithm. Examples of control algorithms include, but are not limited to, threshold based control algorithms or algorithms based on ramp rate or rate of change of parameters, as discussed below, and/or the like.

An example of a request 55 comprises a request type or objective that conveys the desired change to the parameter, a type of change required and a priority of the request. Examples of request types or objectives include “upper regulate” when the constraint controller 35 is attempting to reduce the value of the parameter at the constraint location 25, “lower regulate” when the constraint controller 35 is attempting to increase the value of the parameter at the constraint location 25, “release” when the constraint controller 35 has resolved its problem and is allowing the distributed generation resource 15 to move back to preferred operating points, and “fail safe” when the constraint controller 35 has lost communication with the measuring systems MP1, MP2, MP3, MP4 at the constraint location 25 and requires all associated distributed energy resources 15 to move to fail-safe operating points.

The type of change may not be required for “fail safe” request types as the objective is evident. For the other request types, the type of change may be unidirectional (for upper and lower regulate request types) or bidirectional (for release request types). As examples, a unidirectional type of change may comprise either reducing or increasing the value of one or more of the parameters by a certain amount or to below a certain level. As examples, a bidirectional type of change may specify a maximum permitted change or increase and decrease in the value of one or more of the parameters. The priority conveys an indication of the relative importance of the request 55. The priority is specified by the control algorithm of the constraint controller 35, e.g. depending on the value of the parameter(s) and/or the rate of change thereof relative to one or more thresholds or criteria, which may be associated with different priorities. For example, in a set of escalating threshold values such as a global trip, sequential trip, and trim threshold scheme, global trip has the highest priority. The priority is provided to assist the device controllers 50 in the selection of control actions and to assist with arbitration between requests from different constraint controllers 35. Further details of suitable multi-threshold or trigger level schemes can be found in EP2648302, the contents of which are hereby incorporated by reference as if set out in full herein.

The constraint controllers 35 are configured to publish requests 55 by broadcasting the requests 55 via a bus such as an enterprise service bus or via a wired or wireless communications network or the like. For example, the constraint controllers 35 can be configured to broadcast the requests 55 using a publish-subscribe messaging protocol, or a telemetry protocol such as the industry standard IEC-61850 or DNP 3.0 protocols. The requests 55 are queued in the request queue 40 and retrieved by any of the device controllers 50 that subscribe to the particular request 55. As such, the constraint controllers 35 don't address the requests 55 to specific device controllers 50 and indeed don't need to know any details of any of the device controllers 50. Instead, the constraint controllers 35 can simply generally publish/broadcast the request 55 containing some form of classifying information that allow constraint controllers 55 to identify if the request 55 relates to a constraint location 25 that is affected by a device managed by the constraint controller 55, so that the constraint controller can “subscribe” to such requests 55. This communication approach greatly complements the decoupled, logically and functionally separated arrangement of constraint controllers 35 and device controllers 50 provided by embodiments of the present invention.

Requests from any given constraint controller 35 can be retrieved and actioned by one and/or more than one device controller 50. In situations where more than one device controller can retrieve and action requests 55 from a given constraint controller 35, then the device controllers 50 can optionally be configured to communicate with each other, e.g. via a suitable communications network or bus. This allows the controllers 50 to coordinate a suitable response or reaction to the request so that the device controllers 50 address the condition at the constraint location 25 as a whole or group rather than individually or in isolation so as to avoid an over-reaction to the request or condition.

The bus or communications network comprises or implements the request queue 40, which may be comprised in data storage coupled to the bus or communications network. The device controllers 50 receive or retrieve the requests 55 from the request queue 40.

The device controllers 50 each control one or more devices, such as the generation resources 15. In this example, different device controllers 50 manage different areas of the power network 5, i.e. different device controllers 50 manage different distinct subsets of the devices 15, 20. However, it will be appreciated that this need not necessarily be the case. The device controllers 50 receive the requests 55 from one or more constraint controllers 35 via the request queue 40. The device controllers 50 are provided with a control scheme that specifies the logic used to process the requests 55 and to determine what action to take to suitably respond to the requests 55. The device controllers 50 issue control commands to control the devices such as the generation resource 15 based on the actions determined using logic of the control scheme based on the requests 55 the device controller 50 has received.

The control system implements open loop operation. In other words, the constraint controllers 35 send requests to the device controllers 50 but there is no feedback from the device controllers 50 to the constraint controllers 35. Instead, if the initial condition at the constraint location 25 is not satisfied by an action taken by the devices 15, 20 under the control of the device controller(s) 50, then the constraint controller 35 will continue to issue requests 55 to the device controller(s) 50 until such times as the condition is resolved.

In this way, there is a separation or decoupling of the monitoring of the constraint locations 25 to determine conditions that require action and the determination and control of the actions taken (i.e. the control of the devices 15, 20, such as the generation resources 15) to try to resolve the conditions.

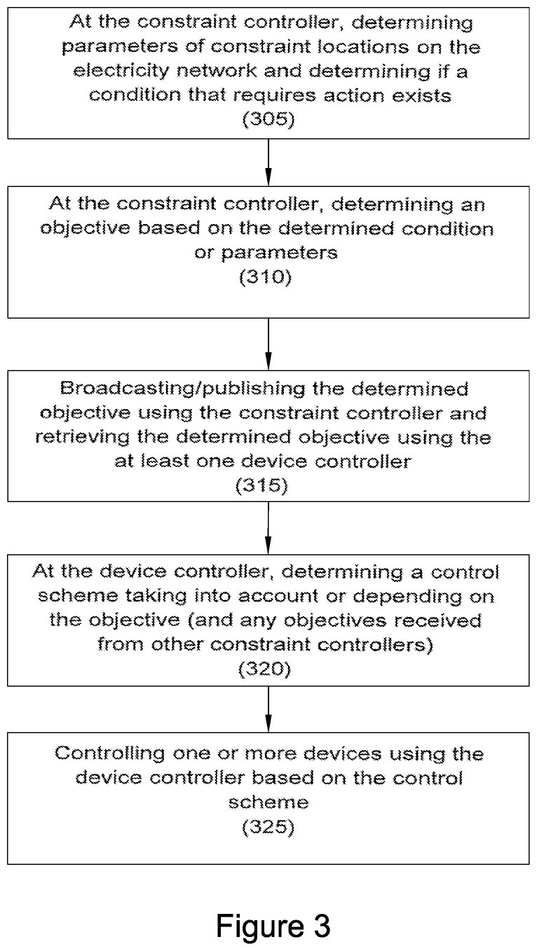

An example of a method of operating the control system of FIG. 2 is shown in FIG. 3.

At step 305, the constraint controllers 55 receive the values of the parameter(s) from the measuring systems MP1, MP2, MP3, MP4 and determine any further parameters that are required that are calculated from the values received from the measuring systems MP1, MP2, MP3, MP4. The constraint controllers 35 monitor the values of the parameters (including the further parameters) and assess these using the control algorithm to determine if a condition that requires action exists.

If the constraint controller 35 determines that a condition that requires action exists, then the constraint controller 35 issues a request 55 to try to resolve the condition. In step 310 the constraint controller 35 determines what request (i.e. the contents of the request) should be sent based on the determined values of the parameters using the control algorithm. For example, the control algorithm specifies what values of the parameters (or values derived therefrom such as rate of change or ramp rate or other function of the parameters) constitute a condition to be resolved and what request (e.g. what request type or objective, type of action and/or priority) is associated with those values of the parameters. The constraint controller 35 then broadcasts the appropriate request 55 to be held in the request queue 40. The request 55 is then retrieved by any device controllers 50 that subscribe to requests 55 relating to that constraint location 25 or constraint controller 35 from the request queue 40 via the bus or communications network in step 315.

After retrieving the request 55, in step 320 the device controller 50 determines a control scheme for controlling any devices, such as the generation resources 15, controlled by that device controller 50 based on the request 55 received from the constraint manager 35 along with any other requests 55 received from other constraint managers 35. The device controller 50 is provided with a control strategy or policy that it can use to determine the appropriate control scheme for controlling the devices 15, 20 depending on the requests 55 it receives from the constraint managers 35. This may also involve some collaboration with other device managers 50 to coordinate an appropriate overall response.

The control strategy or policy maps the request type or objective and type of action of each request 55 onto a control action for controlling one or more or each of the devices 15, 20 controlled by the device controller 50. The request type and/or priority of each request 55 can be used to arbitrate between potentially conflicting requests 55 from different constraint controllers 35 when multiple requests 55 from different constraint controllers 35 have been received, e.g. based on a pre-provided conflicts policy.

Once the device controller 50 has determined the appropriate control scheme for the requests 55 it has received, the device controller issues the appropriate control commands to the relevant devices 15, 20 required to implement that control scheme in step 325.

The decoupling of the monitoring and condition determination from the decisions regarding what action to take and how to control the devices 15, 20 can potentially lead to significant advantages in the context of active network management of electrical power networks. For example, different control strategies can be employed at constraint locations 25 or between different constraint locations 25 to best suit a problem being solved. For example, ramp-rate control could be employed at one constraint location 25 while threshold-based control could be employed at a different constraint location 25. The above method makes the device controller 50 of the control system 30 agnostic to what the constraint controller 35 is attempting to achieve. In addition, it can potentially be easier for the device controllers 50 can be enhanced, upgraded, replaced or altered to provide new control strategies or policies without affecting the method used by the constraint controllers 35. An example is replacing the control of reactive power output of generation resources 15 with the control of an on-load tap changer. Furthermore, the above method can make it easier to have a capability for one vendor to provide the constraint monitoring and constraint controllers 35 as a service, while another vendor can provide a device controller 50 service to satisfy the objectives set by the constraint controllers 35. This is particularly relevant with the increased presence of aggregators within the power supply industry.

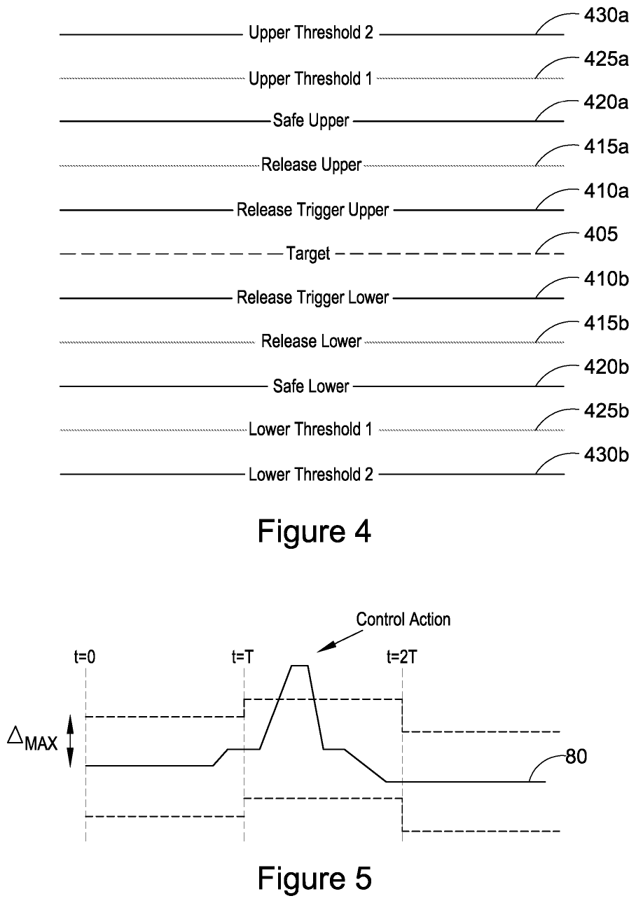

Two respective examples of control algorithms that could be used by the constraint controllers 35 are shown in FIGS. 4 and 5. Although these control algorithms are particularly beneficial when implemented by the constraint controllers 35 of the system described above that has separated/decoupled monitoring and actions, it will be appreciated that these control algorithms or suitable adaptions thereof can also be applied to other active network management systems, such as those described in GB2460504 and WO 2009/063220 A2, the contents of which are incorporated by reference as if set out in full herein.

FIG. 4 illustrates a threshold based control algorithm. In particular, multiple upper and lower thresholds for the at least one parameter that is determined by the constraint controllers 35 are provided, the upper thresholds 410a to 430a being higher than a target value 405 for the parameter whilst the lower thresholds 410b to 30b are less than the target value 405 for the parameter. The upper thresholds 410a to 430a comprise (in order of increasing value of the parameter) a release trigger upper threshold 410a, a release upper threshold 415a, a safe upper limit 420a, a first upper threshold 425a and a second upper threshold 430a. The lower thresholds comprise (in order of decreasing value of the parameter) a release trigger lower threshold 410a, a release lower threshold 415a, a safe lower limit 420a, a first lower threshold 425a and a second lower threshold 430a.

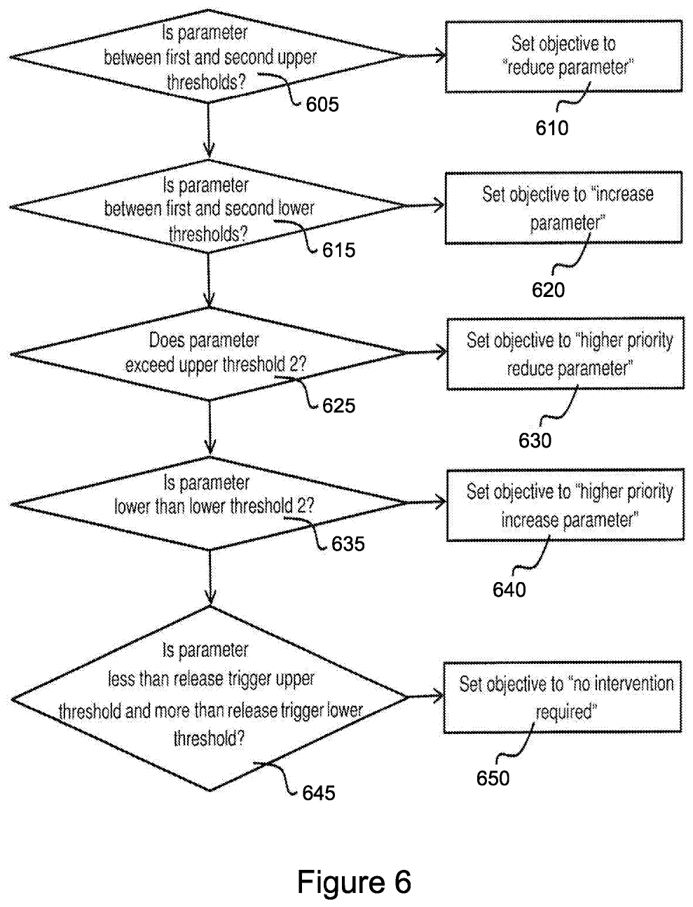

The operation of the control algorithm of FIG. 4 is illustrated in FIG. 6. The constraint manager 35 determines if the value of the parameter exceeds the first upper threshold 425a but is lower than the second upper threshold 430a (step 605). If so, then the objective is set to “reduce the parameter” (step 610). The constraint manager 35 determines if the value of the parameter is between the first lower threshold 425b and the second lower threshold 430b (step 615). If so, then the objective is set to “increase the parameter” (step 620). The constraint manager 35 determines if the value of the parameter is equal to or greater than the second upper threshold 430a (step 625) or if the value of the parameter is equal to or less than the second lower threshold 430b (step 635). If so, then the objective is set to “higher priority increase/reduction (respectively/as appropriate) in parameter” (step 630 or step 640). The constraint manager 35 determines if the value of the parameter is lower than the release trigger upper threshold 410a and more than the second lower threshold 410b (step 645). If so, then the objective is set to “no intervention required” (step 650). The device controller 50 responds to this objective by resuming preferred or default operation of the devices 15, 20. The resumption of the preferred or default operation of the devices should be achieved whilst keeping the value of the parameter within the release upper and release lower thresholds 415a, 415b, which are respectively set higher than the release upper threshold 410a but below the upper safe limit 420a and lower than the release lower threshold 410b but above the upper lower limit 420b. Different priorities are associated with each set of thresholds 410-430, with the priority associated with each threshold 410-430 increasing with increasing difference between the threshold 410-430 and the target value 405 for the parameter. In this way, the second upper thresholds 430a, 430b have the highest priority and the first upper thresholds have a lower priority than the second upper thresholds but higher than the release trigger thresholds, which have the lowest priority.

The parameter value entering the trigger zone 410a, 410b starts a periodic release process, where the constraint controller 35 issues requests comprising an objective that is interpreted by the device controller 50 to give rise to an action of moving the devices 15, 20 back to their preferred operating points, with a constraint of a ±change in the parameter value allowed at the constraint location 25. These requests are periodically issued until the measured parameter value moves outside the release zone 415a, 415b. Once outside the release zone 415a, 415b, the constraint controller 35 enters an idle state where it no longer issues requests until either an upper or lower threshold 425a, 425b, 430a, 430b is breached or the measured parameter value moves back into the release trigger zone 410a, 410b.

Although a particular example of a multi-threshold scheme is illustrated in FIGS. 4 and 6, it will be appreciated that other control algorithms could be used. For example, the control algorithm could implement a scheme that comprises defines a plurality of ranges defined by upper and lower thresholds that result in different requests being broadcast by the constraint controller 35. Each request is interpreted by the device controllers 50 to produce different actions for the devices 15, 20, e.g. a global trip, sequential trip, trim and reset, dependent on the different requests. In this case, the parameter value breaching one of the thresholds results in an objective being broadcast that is interpreted by the device controller 50 to result in a trim action of reducing the output of devices 15, 20 that contribute to the parameter at the constraint location 25 in a defined order until the measured value is at the reset level/threshold. The parameter value breaching another of the thresholds results in an objective being issued that is interpreted by the device controller so as to result in a sequential trip action of tripping distributed generation resources 15 that contribute to the parameter at the constraint location 25 to be tripped in a defined order until the measured parameter is at the reset level/threshold. The parameter value breaching another of the thresholds results in an objective being issued that is interpreted by the device controller 50 to result in the global trip action involving tripping of all distributed generation resources 15 that contribute to the measured parameter at the constraint location. When the parameter value drops within the reset thresholds, then the problem at the constraint location 25 is deemed to be resolved and the objective is broadcast that is interpreted by the device controller to result in the generation resources 15 being brought back towards their desired/default operating points, while ensuring that the measured parameter doesn't breach the trim thresholds.

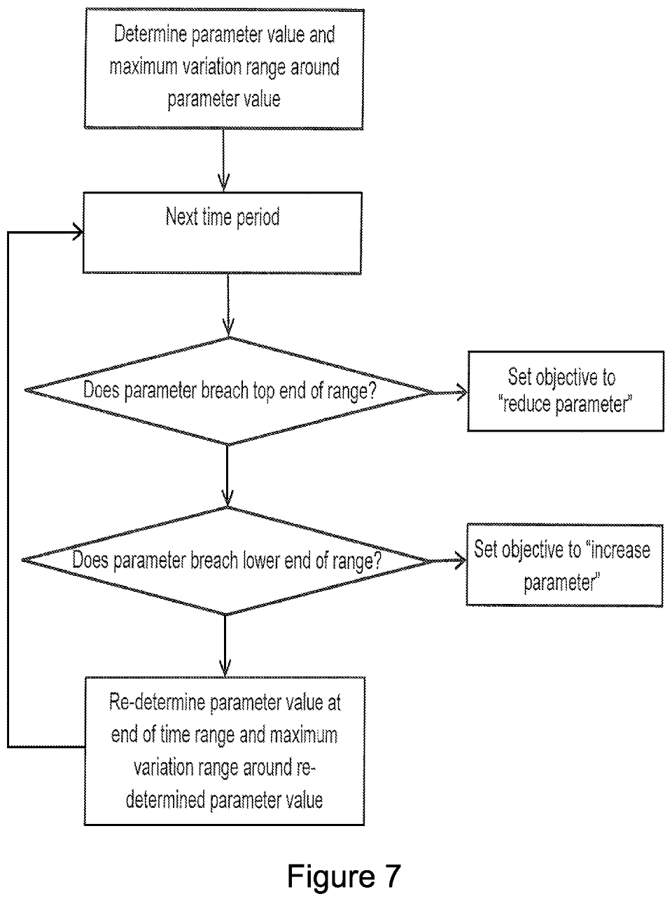

Other control algorithms are also possible. As another example, the constraint controllers 35 could use an algorithm based on the ramp rate of the parameter, for example as shown in FIGS. 5 and 7.

In this control algorithm the movement or ramp rate of the parameter is monitored. In particular, the parameter is monitored by the constraint controller 35 in consecutive time periods T. At the beginning of each time period T, a range corresponding to a predetermined maximum deviation from the current value of the parameter is determined. The maximum deviation is constant, but the value of the parameter at the beginning of each time period may vary, so the range may also vary between time periods. If the value of the parameter exceeds a top or upper end of the range, then an objective of reducing the value of the parameter is determined. If the value of the parameter exceeds a bottom or lower end of the range, then an objective of increasing the value of the parameter is determined.

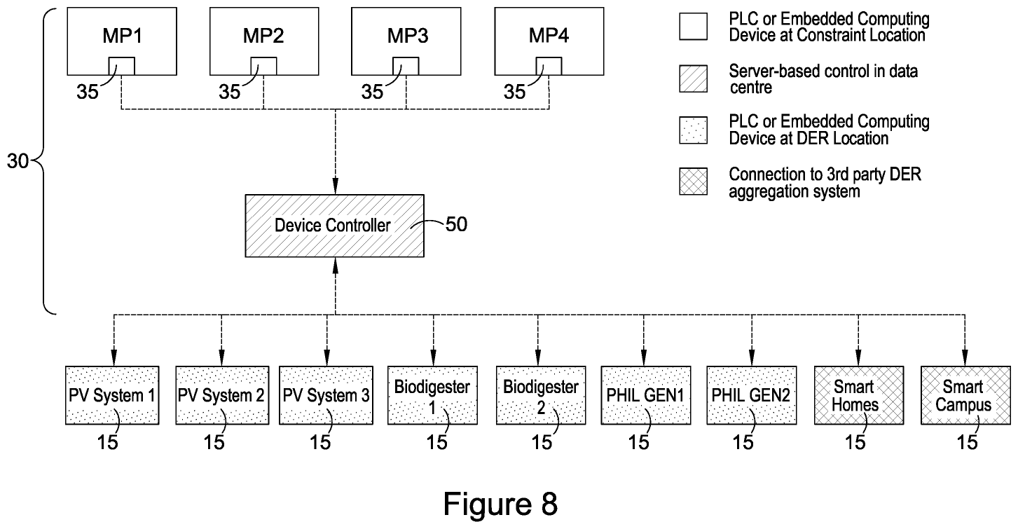

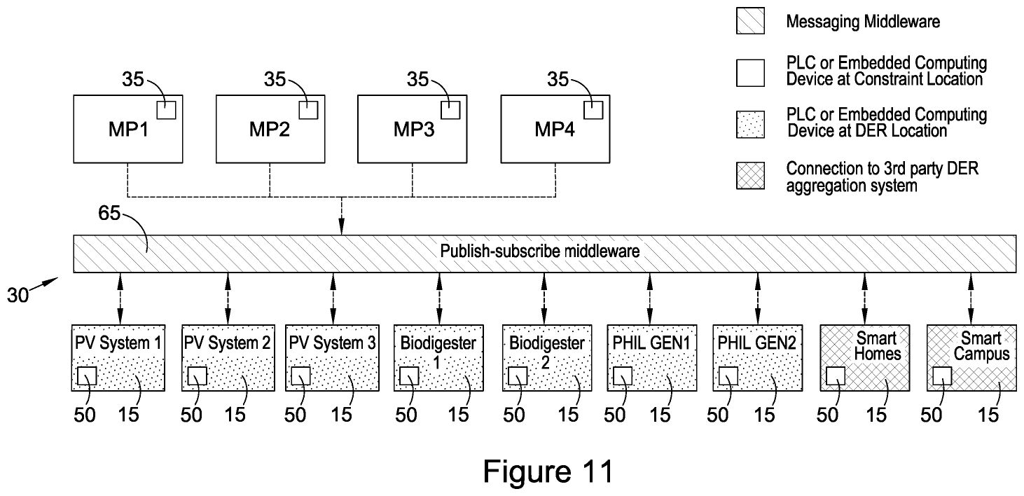

There are also various possible implementation of the control system 30 and associated methods described above that implement the concepts described above in relation to FIGS. 1 to 7, a first example of which is illustrated in FIGS. 8 to 10 and a second example of which is illustrated in FIGS. 11 to 13.

FIGS. 8 to 10 illustrate an example of a network that uses the functionality of the constraint controllers 35 and the device controller 50 described above. In this case, the plurality of measuring systems MP1, MP2, MP3, MP4 are responsible for obtaining measurements of parameters at constraint locations and each incorporates an associated constraint controller 35 that determines goals or objectives for the parameters at the respective constraint location based on the measurements of the parameters. One or more distinct and separate device controllers 50 that implement logic that determines how to control the respective devices responsive to the goals or objectives received from the constraint controllers 35 and then controls the devices accordingly. The example of FIGS. 8 to 10 is described with reference to the power network of FIG. 1, but is not limited thereto.

In particular, as shown in FIG. 8, the measuring systems MP1, MP2, MP3, MP4 are provided at constraint locations 25 and each comprises the associated constraint controllers 35. The constraint controllers 35 are in communication with one or more device controllers 50 using telecontrol protocols such as Modbus, IEC60870-104 and the like. The one or more device controllers 50 are in turn in communication with each of the devices, particularly the generation resources 15, and connected 3^{rd} party microgrids or aggregation systems 70 to provide for the sending of control commands that instruct specific operation of the devices 15, 70.

For each constraint location 25, the constraint controller 35 implements a constraint control algorithm to monitor the measurements of the parameters and produce control requests 55 to keep the parameters at the constraint location 25 within required limits. The device controller 50 implements a device control algorithm and manages the requests 55 received from the individual constraint controllers 35 and issues control requests 55 to distributed generation resources 15 to satisfy each of the requests 55.

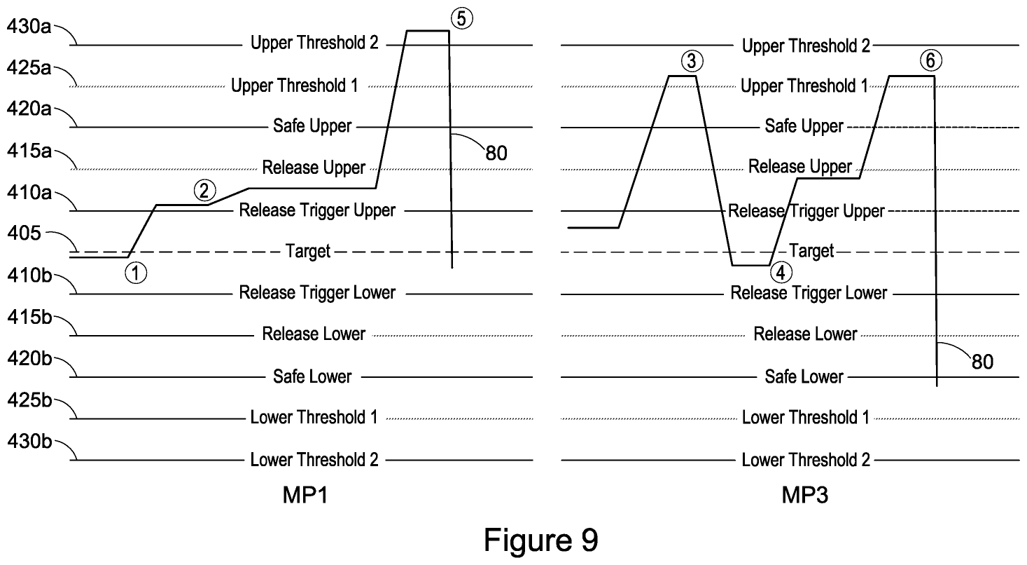

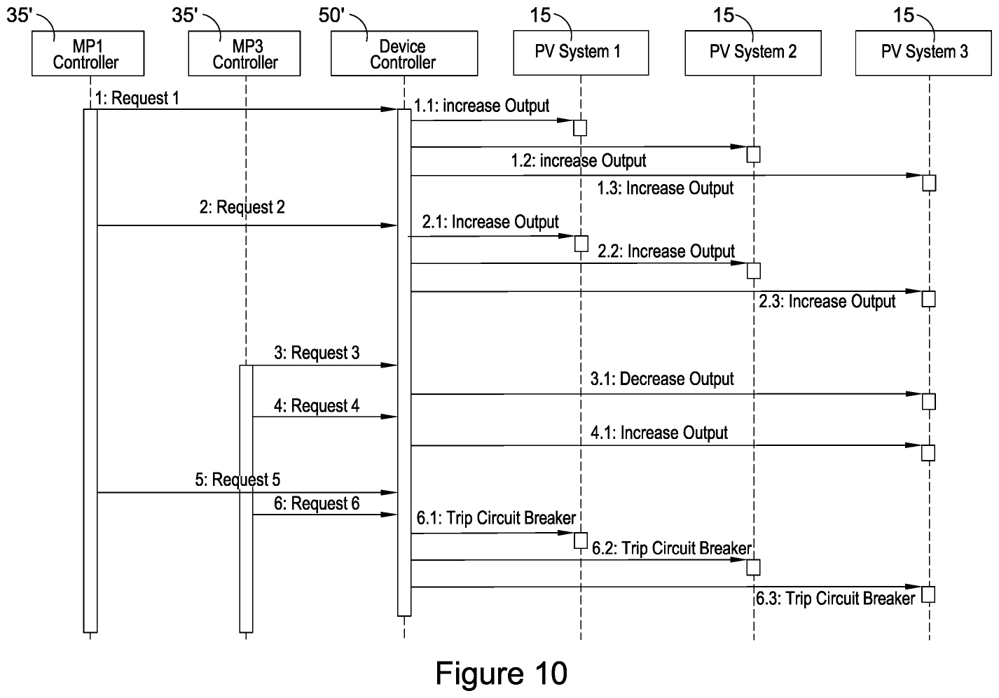

A worked example of the control scheme applied to devices that are generation resources 15 in the form of PV Systems under control of the device controller 50 implemented by the device control algorithms with only measuring systems MP1 and MP3 having constraint controllers is illustrated with reference to FIGS. 9 and 10. The device controller 50 receives telemetry or issues control commands to devices (e.g. the generation resources 15) using industry standard telemetry protocols.

FIG. 9 illustrates the measured current at each of the constraint controller locations, with annotations illustrating the requests (request number) issued by the constraint controllers. FIG. 9 shows the thresholds 405-430 used by the constraint controller 35 to determine when a request should be sent and which request, along with a trace 80 showing the variation of the parameter with time. The horizontal or x-axis in FIG. 9 is time and the vertical or Y-axis is the magnitude of the value of the parameter. Table 1 below describes the content of the requests.

TABLE 1
Requests Issued (ref. FIGS. 9 and 10)

| Request | Request | | Request |
|---|---|---|---|
| Number | Type | Associated Δ In Current | Priority |
| 1 | Release | Up: Release Upper - Measured | 1 |
| | | Down: Measured - Release Lower | |
| 2 | Release | Up: Release Upper - Measured | 1 |
| | | Down: Measured - Release Lower | |
| 3 | Regulate | Up: 0 | 1 |
| | upper | Down: Measured - Target | |
| 4 | Release | Up: Release Upper - Measured | 1 |
| | | Down: Measured - Release Lower | |
| 5 | Regulate | Up: 0 | 2 |
| | Upper | Down: Measured - Target | |
| 6 | Regulate | Up: 0 | 1 |
| | Upper | Down: Measured - Target | |

The sequence diagram in FIG. 10 illustrates the communication between the constraint controllers 35 and device controllers 50 that takes place to achieve the overall system operation. In FIG. 10, the constraint controllers 35, device controller 50 and the devices (e.g. generation resource 15) controlled by the device controller 50 are provided along the horizontal or x-axis, time (in chronologically evolving order) extends down the vertical or y-axis. Thick lines indicate an action being taken by the associated controller or device (35, 50, 15), dashed lines indicate no action being taken, horizontal arrows indicate communications such as requests being sent in the direction of the arrow.

The device controller 50 aims to satisfy release requests by sharing the available change in current between each of the PV systems (generation resources 15) by increasing their real power output by a suitable amount. The device controller 50 satisfies “priority 1” regulate requests by decreasing the real power output of all devices (e.g. generation resources 15) that could have an effect at the associated constraint location 25. Again, the decrease is shared equally between devices 15. The device controller satisfies “priority 2” regulate requests by opening a circuit breaker at each device 15 that can have an effect on the measured value at the constraint location 25. The control system 30 and associated methods remove complexity from the constraint controller 35 because the device controller 50 handles the process of issuing requests to devices 15 to satisfy the request 55.

Conditions 1 and 2 on FIG. 9 result in first and second requests in FIG. 10 that request a release of the device. The device controller 50 interprets this request, determines the status of the devices 15, 20 and, based thereon, makes a decision to increase output from the devices/generation resources 15 to bring them closer to their optimum operation. In this way, the device controller 50 receives the request, decides a control command based on the request and other considerations such as an operating state of the devices 15, 20 and requests from other constraint controllers 35, and issues the control commands to the devices/generation resources 15 to increase output. It can be observed from the first and second requests in the example of FIGS. 9 and 10 that the device controller 50 was not able to fully satisfy the first request from the constraint controller 35. For example, the devices 15 did not fully respond to the controller's instruction. As such, the second request 55 was issued by the constraint controller 35 to achieve its target value. It can be observed from third and fourth requests that only PV System 3 is affected by a request 55 from the measurement system MP3 because changes to the output of PV systems 1 and 2 have no effect on this constraint location. Condition 3 shown in FIG. 9 results in a decrease output request being issued whilst condition 4 shown in FIG. 9 results in an increase output request being issued.

The at least one device controller 50 described above has to arbitrate between requests from different constraint controllers 35. This is demonstrated by the simultaneous issuing of requests 5 and 6 in FIGS. 9 and 10, see also Table 1 above. As illustrated and as can be seen from Table 1, measuring system MP1 issues a “priority 2” request 55 (request 5) and measuring system MP3 issues a “priority 1” request 55 (request 6). The logic specified in the control strategy or policy of the constraint controller 35 in this situation is to satisfy the priority 2 request over the priority 1 request. Further arbitration rules could be employed when dealing with multiple requests 55 at the same priority level. For example, the requested change in measured value could also be taken into consideration.

This example demonstrates how the above system and methods can simplify the implementation of a control system 30 by separating the concerns of device control and constraint location control. This provides the opportunity for parts of a control system to be provided by different vendors.

An alternative example is shown in FIGS. 11 to 13, with functionally similar or equivalent components being afforded the same or equivalent numerals to the systems described above. Furthermore, the format and arrangement of FIG. 13 is the same as that used for FIG. 10. The example of FIGS. 11 to 13 more clearly demonstrates a highly beneficial new capability to remove centralised control elements such as system controllers entirely. In the example of FIGS. 11 to 13, the constraint controller 35 and device controller 50 functionality is provided in the control hardware at constraint and device locations respectively. FIGS. 11 to 13 illustrate this distributed and physically separated architecture.

As can be seen from FIG. 11, the constraint controllers 35 are provided embedded in hardware at respective constraint locations 25. The device controllers 50 are embedded in hardware at the locations of the devices, e.g. the distributed generation resources 15 or within the third party aggregation systems 70, which are remote from the constraint controllers 35. The constraint controllers 35 are in communication with the device controllers 50 via a publish-subscribe middleware 65. In particular, the constraint controllers 35 are configured to send requests via the publish-subscribe middleware 65 to the device controllers 50. The device controllers 50 communicate and co-operate with each other to satisfy control requests issued by the constraint controllers 35. In this way, the plurality of device controllers 55 act together to respond to the requests 55 issued by the constraint controllers 35 in a cooperative, unitary manner rather than individually, which could otherwise lead to an over-reaction.

In this example, regulate upper requests are satisfied by controlling the output of generation resources 15, with priority 2 requests being satisfied by opening circuit breakers. Release requests are satisfied by controlling the output of generation resources 15. Where more than one device/generation resource 15 can be used to satisfy a request 55 from a constraint controller 35, the required change in output is equally shared between the devices/generation resources 15.

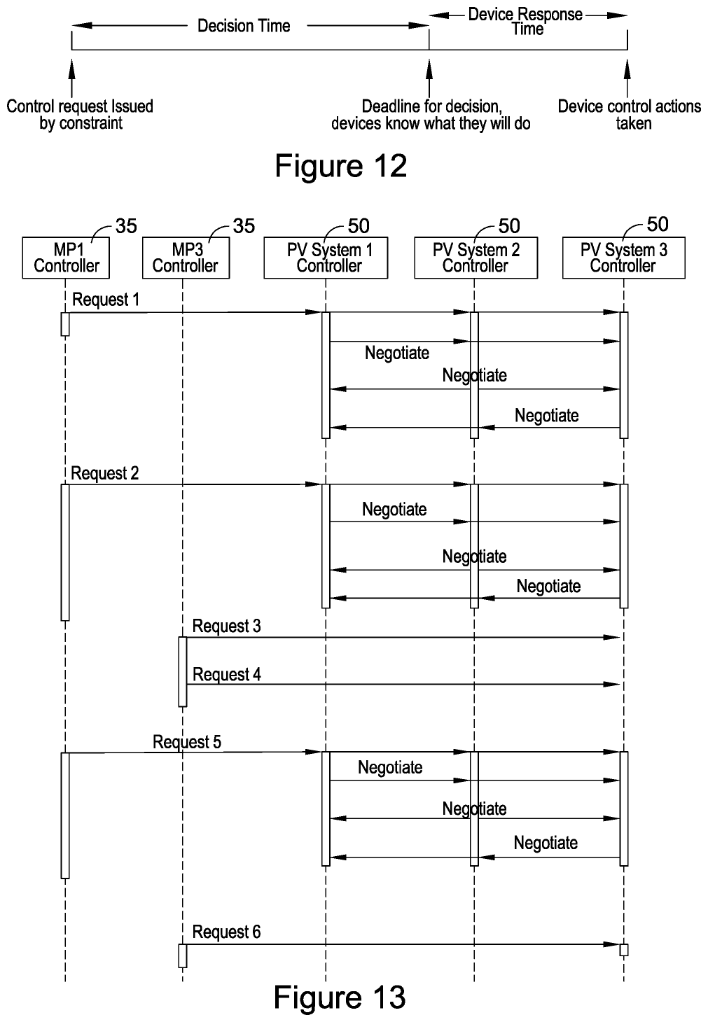

As can be seen from FIGS. 12 and 13, when a constraint controller 35 generates a request 55, the publish-subscribe middleware 65 is responsible for passing the request 55 onto each of the devices/generation resources 15 that is associated with that constraint location 25. This is followed by a negotiation period where the device controllers 50 communicate in a peer-peer manner to decide on the control action to be taken. This time is indicated as “decision time” in FIG. 12. The system sets deadlines for the device controllers 50 to decide which device controller(s) will react to the request 55. Once a decision has been reached, the devices execute the required control actions within a device response time.

The sequence diagram in FIG. 13 illustrates the communication involved in satisfying requests 55 from the constraint controller 35. Negotiation only needs to take place between elements of the system that are concerned with solving a problem from a particular constraint location 25. Requests from the measuring system MP3 only have to be delivered to PV System 3 (as only PV system 3 has an effect at the constraint location 25 monitored by measuring system MP3), and no negotiation is required to service these requests. The only arbitration that needs to be carried out to satisfy requests from both constraint locations 25 is within the device controller 50 of PV System 3.

A skilled person will appreciate that the system structure and code could be implemented in a variety of forms, including hardware and software, without departing from the invention. Implementation of the invention need not necessitate the installation of new equipment as an appropriate configuration of existing equipment may be sufficient. This might include existing Supervisory Control and Data Acquisition (SCADA) systems, Network Management Systems (NMS) or other control system used by power network operators.

Method steps of the invention can be performed by one or more programmable processors executing a computer program to perform functions of the invention by operating on input data and generating output. Method steps can also be performed by special purpose logic circuitry, e.g., an FPGA (field programmable gate array) or an ASIC (application-specific integrated circuit) or other customised circuitry. Processors suitable for the execution of a computer program include CPUs and microprocessors, and any one or more processors. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g. EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented on a device having a screen, e.g., a CRT (cathode ray tube), plasma, LED (light emitting diode) or LCD (liquid crystal display) monitor, for displaying information to the user and an input device, e.g., a keyboard, touch screen, a mouse, a trackball, and the like by which the user can provide input to the computer. Other kinds of devices can be used, for example, feedback provided to the user can be any form of sensory feedback, e.g., visual feedback, auditory feedback, or tactile feedback; and input from the user can be received in any form, including acoustic, speech, or tactile input.

It will be appreciated that, in examples, the monitoring devices or constraint controllers are provided physically separated, remote from and spaced apart from the device controllers, for example, the monitoring devices or constraint controllers could be provided at respective constraint locations (so called points on the power network) whilst the device controllers could be provided at or in the respective devices (such as the generation resources) that they control.

1. A distributed and decentralized control system for a power network, the control system comprising:
at least one monitoring device or constraint controller for monitoring, determining or measuring at least one parameter of one or more points on the power network; and
one or more device controllers for controlling at least one device connected or connectable to the power network; wherein
the at least one monitoring device or constraint controller is configured to broadcast or transmit a request or objective that depends on the parameter or a condition of the one or more points on the power network derived therefrom; and
the one or more device controllers are configured to retrieve or receive the broadcast or transmitted request or objective and to implement logic to determine a control action for the at least one device at least partially based on the request or objective;
such that the monitoring, determining and measuring of the parameters of the one or more points on the power network is physically and logically decoupled or separated from the control of the devices.

2. The control system of claim 1, wherein the at least one point on the network is a constraint point.

3. The control system according to claim 1, wherein the device controller is configured to determine the control action and/or how to control the at least one device based on the request or objective, one or more other requests or objectives received from at least one other of the monitoring devices and a condition of the at least one device.

4. The control system according to claim 1, wherein the request or objective specifies one or more of: reducing the value of the at least one parameter of the one or more points on the power network, increasing the value of the at least one parameter of the one or more points on the power network, releasing control of at least one of the devices, and/or fail safe or other safe condition.

5. The control system according to claim 1, wherein the monitoring device or constraint controller is configured to implement a control algorithm for determining the condition of the point on the network from a plurality of possible conditions.

6. The control system of claim 5, wherein the monitoring device or constraint controller is configured to send different requests or objectives for different determined conditions and/or the requests or objectives may be indicative of a corresponding determined condition.

7. The control system according to claim 1, wherein the request or objective is for the one or more points on the network and does not specify an operation or target parameter value for the at least one device that is connected or connectable to the power network.

8. The control system according to claim 1, wherein the device controller is configured to receive requests or objectives from a plurality of different monitoring devices or constraint controllers for corresponding different points on the power network and arbitrate and/or otherwise take into account the requests or objectives from the plurality of different monitoring devices or constraint controllers in determining the control action for the at least one device.

9. The control system according to y preceding claim 1, wherein the request comprises a priority and the device controller is configured to determine how to control the at least one device associated with the controller at least partially based on the priority of the request and/or the priority of the one or more other requests received from the at least one other of the monitoring devices.

10. The control system according to claim 1, wherein the device controller is configured to determine which of the at least one devices to control and/or how to control the at least one device associated with the device controller based on a policy or control strategy that specifies which devices to control and/or how and/or when to control the devices.

11. (canceled)

12. The control system according to claim 1, wherein the at least one device is at least one device that has an effect greater than a predetermined minimum effect on the one or more points on the power network.

13. The control system according to claim 1, wherein the at least one monitoring device or constraint controller is physically separated, remote and distinct from the one or more device controllers.

14. (canceled)

15. The control system according to claim 1, wherein the at least one monitor is configured to broadcast or transmit the request or objective over a communications network or bus and one or more or all of the device controllers are configured to receive the request or objective via the communications network or bus.

16. (canceled)

17. The control system according to claim 15, wherein the communications network or bus comprises a request queue and the monitoring devices are configured to broadcast or transmit the request or objective by issuing the request or objective to the request queue and one or more or all of the device controllers are configured to retrieve and/or consume the requests or objectives from the request queue.

18. (canceled)

19. The control system according to claim 1, wherein the one or more device controllers are configured to determine the control actions without reference to a model of the full network.

20. A power network comprising the control system of claim 1, and at least one device receiving power from or providing power to the power network, the at least one device being controlled or controllable by the device controller of the control system.

21. A monitoring device or constraint controller for monitoring, determining or measuring at least one parameter of one or more points on a power network,
the monitoring device or constraint controller comprising, and/or being configured to receive data from, one or more data providing sensors for measuring or monitoring the one or more points on the power network;
the data comprising values of the one or more parameters and/or the monitoring device or constraint controller being configured to determine the values of the one or more parameters from the data; wherein
the monitoring device or constraint controller is configured to determine a request or objective based on the values of the one or more parameters and/or a condition of the one or more points on the power network derived therefrom, and to broadcast or transmit the request or objective.

22. (canceled)

23. A device controller configured to:
receive or retrieve at least one request or objective that was broadcast or transmitted by one or more monitoring devices or constraint controllers;
determine a control scheme, action or command for controlling one or more devices connected to an power network based on the received request(s) or objective(s); and
control the at least one devices based on the determined control scheme, action or command.

24. A method of operating a distributed and decentralized control system for a power network, the method comprising:
monitoring, determining or measuring at least one parameter of one or more points on the power network using at least one monitoring device;
using the at least one monitoring device, broadcasting or transmitting a request or objective based and/or dependent on the at least one measured or monitored parameter and/or a condition of the one or more points on the power network derived therefrom;
retrieving or receiving the signal using the at least one device controller; and
controlling the at least one device using one or more device controllers based on the request or objective.

25. A computer program or computer program product provided on a non-transient computer readable medium, the computer program configured such that when run on a processing system causes the processing system to implement the method of claim 24.
